(19) United States
(12) Patent Application Publication
(10) Pub. No.: US 2015/0077248 A1
(43) Pub. Date: Mar. 19, 2015

(54) Smoke Detectors with Wireless Local Area Network Capabilities

(71) Applicant: Microchip Technology Incorporated, Chandler, AZ (US)

(72) Inventor: Arthur B. Eck, Gilbert, AZ (US)

(21) Appl. No.: 14/029,770

(22) Filed: Sep. 17, 2013

(51) Int. Cl. G08B 17/10; G08B 25/10

(52) U.S. Cl. CPC G08B 17/10; G08B 25/10
USPC 340/539.26

(57) ABSTRACT

An apparatus is configured to provided smoke detection and wireless local area network capabilities at each location thereof. This apparatus may replace existing smoke detector devices and/or be used in new construction so as to provide both smoke detection and wireless local area network capabilities in an area proximate to the apparatus. Carbon monoxide (CO) and/or carbon dioxide (CO₂) monitoring and alarm may also be incorporated into this apparatus. Local area network capabilities may be wireless local area network (WLAN), e.g., WiFi per IEEE 802.11 standard, etc. The smoke detector apparatus may be used as an Ethernet transceiver, wireless router, wireless repeater, etc., and may be coupled to a wired or wireless local area network Ethernet switch or router that may further be used to provide Internet capabilities in combination with an Internet modem coupled to Internet access, e.g., fiber optic, cable, DSL, etc., supplied by an Internet provider.

### TECHNICAL FIELD

The present disclosure relates to smoke detectors with additional capabilities, and, more particularly, to smoke detectors with wireless local area network capabilities.

### BACKGROUND

Many municipalities, states and countries may require smoke alarms through building codes, e.g., 2012 International Residential Code (IRC), in each sleeping room, outside each separate sleeping area in the immediate vicinity of the bedrooms, and on each additional story of the dwelling, including basements (IRC 314.3). Smoke detectors may be powered from the AC line and may have a battery backup. A single backup battery may be provided for a plurality of smoke detectors, e.g., in industrial installations where the one main battery backup may be used instead of a backup battery at each smoke alarm.

“Where more than one smoke alarm is required to be installed within an individual dwelling unit in accordance with IRC Section R314.3, the smoke alarm devices shall be interconnected in such a manner that the actuation of one smoke alarm will activate all of the smoke alarms in the individual unit (IRC 314.5). The building code required smoke alarms silently sit in place, hopefully never to be needed. Wouldn't it be nice to utilize these strategically located smoke detector devices having a supply of electrical power connected to them for other useful and advantageous purposes?

### SUMMARY

Therefore, there is an opportunity for providing wireless local area network capabilities in smoke detector devices required for providing smoke alarms that are strategically located in a home and having electrical power supplied thereto. Existing smoke detector devices may be easily replaced with smoke detector devices with wireless local area network features and functions, and new construction installations may similarly benefit at minimal additional cost to just installing standard smoke detectors.

According to an embodiment, an apparatus for detecting smoke and providing wireless local area network communications may comprise: a logic device; a smoke sensor coupled to the logic device; an audio amplifier coupled to the logic device; a speaker coupled to the audio amplifier; network store and forward logic and memory; a communications interface coupled to the network store and forward logic, wherein the communications interface comprises a wireless interface coupled to a radio frequency antenna; and a power supply coupled to and powering the logic device, the network store and forward logic, communications interface and audio amplifier; wherein when the smoke sensor detects smoke the logic device generates at least one smoke alarm tone through the audio amplifier and to the speaker, and a smoke alarm signal through the communications interface; and wherein the network store and forward logic through the communications interface communicates with at least one wireless digital device located in an area proximate to a respective one of the plurality of apparatus and a local area network (LAN) such that digital information content transfers between the at least one wireless digital device and the local area network.

According to a further embodiment, the communications interface may further comprise a wired interface coupled to a wired communications bus. According to a further embodiment, the wired communications bus may be an Ethernet local area network. According to a further embodiment, the communications interface may be adapted to communicate with a wireless local area network (WLAN). According to a further embodiment, the WLAN portion of the communications interface may be IEEE 802.11 standard compliant. According to a further embodiment, the smoke sensor may be an ionization chamber smoke sensor. According to a further embodiment, the smoke sensor may be an optical smoke sensor. According to a further embodiment, the communications interface and the network store and forward logic comprise a WLAN router. According to a further embodiment, the communications interface and the network store and forward logic may comprise a WLAN transceiver. According to a further embodiment, the communications interface and the network store and forward logic may comprise a WLAN repeater. According to a further embodiment, the at least one wireless digital device may be selected from the group consisting of a personal computer, a tablet touch screen computer, a wireless home entertainment device, and a smart cell phone.

According to a further embodiment, a carbon monoxide sensor may be provided. According to a further embodiment, a carbon dioxide sensor may be provided. According to a further embodiment, the logic device, and the network store and forward logic and memory may be provided by a microcontroller. According to a further embodiment, the logic device may comprise a microcontroller. According to a further embodiment, the logic device may be selected from the group consisting of a microprocessor, a digital signal processor (DSP), an application specific integrated circuit (ASIC), and a field programmable gate array (FPGA).

According to another embodiment, a system for providing smoke detection and wireless local area network (WLAN) communications may comprise: a plurality of apparatus providing smoke detection and wireless local area network (WLAN) communications, each of the plurality of apparatus may comprise a logic device, a smoke sensor coupled to the logic device, an audio amplifier coupled to the logic device, a speaker coupled to the audio amplifier, network store and forward logic and memory, a communications interface coupled to the network store and forward logic, wherein the communications interface comprises a wireless interface coupled to a radio frequency antenna, and a power supply coupled to and powering the logic device, the network store and forward logic, communications interface and audio amplifier; wherein when the smoke sensor detects smoke the logic device generates at least one smoke alarm tone through the audio amplifier and to the speaker, and a smoke alarm signal through the communications interface; and wherein the network store and forward logic through the communications interface communicates with at least one wireless digital device located in an area proximate to a respective one of the plurality of apparatus and a local area network such that digital information content transfers between the at least one wireless digital device and the local area network.

According to a further embodiment, the local area network may be an Ethernet local area network. According to a further embodiment, the local area network may be the WLAN. According to a further embodiment, the at least one wireless digital device may be selected from the group consisting of a personal computer, a tablet touch screen computer, a wireless home entertainment device, and a smart cell phone. According to a further embodiment, each of the plurality of apparatus may comprise an Ethernet router. According to a further embodiment, each of the plurality of apparatus may comprise an Ethernet transceiver. According to a further embodiment, each of the plurality of apparatus may comprise an Ethernet repeater.

### BRIEF DESCRIPTION OF THE DRAWINGS

A more complete understanding of the present disclosure may be acquired by referring to the following description taken in conjunction with the accompanying drawings wherein:

FIG. 1 illustrates a schematic elevational diagram of smoke detectors with wireless local area network capabilities in a dwelling, according to specific example embodiments of this disclosure;

FIG. 2 illustrates a schematic block diagram of smoke detectors with wireless local area network capabilities in a dwelling, according to a specific example embodiment of this disclosure;

FIG. 3 illustrates a schematic block diagram of smoke detectors with wireless local area network capabilities in a dwelling, according to another specific example embodiment of this disclosure;

FIG. 4 illustrates a schematic block diagram of smoke detectors with wireless local area network capabilities in a dwelling, according to yet another specific example embodiment of this disclosure;

FIG. 5 illustrates a schematic block diagram of smoke detectors with wireless local area network capabilities in a dwelling, according to still another specific example embodiment of this disclosure; and

FIG. 6 illustrates a schematic block diagram of a smoke detector with wireless local area network capabilities, according to specific example embodiments of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

According to various embodiments, an apparatus may comprise both smoke detector and wireless local area network capabilities. This apparatus may replace existing smoke detector devices and/or be used in new construction so as to provide both smoke detection and wireless local area network capabilities in an area proximate to the device. It is contemplated and within the scope of this disclosure that carbon monoxide (CO), carbon dioxide (CO₂), explosive gas, hazardous gas and heat monitoring and alarm may also be provided and configured according the teachings of this disclosure. Local area network capabilities that may be provided are, but not limited to, wireless local area network (WLAN), e.g., WiFi per IEEE 802.11 standard, etc. The smoke detector apparatus may be used as a wireless transceiver, wireless router, wireless repeater, etc., and may be coupled to a wired or wireless local area network switch or router that may further be used to provide Internet capabilities in combination with an Internet modem coupled to Internet access, e.g., fiber optic, cable, DSL, etc., supplied by an Internet provider. According to the building codes smoke detector outlets must provide electrical power and a networked connection for simultaneous smoke alarm actuation in a building if the smoke alarm devices are not approved for wireless actuation. Having electrical power at the smoke detector outlet allows continuous use of electronic circuits in the smoke alarm device without having to replace batteries.

Referring now to the drawing, the details of specific example embodiments are schematically illustrated. Like elements in the drawings will be represented by like numbers, and similar elements will be represented by like numbers with a different lower case letter suffix.

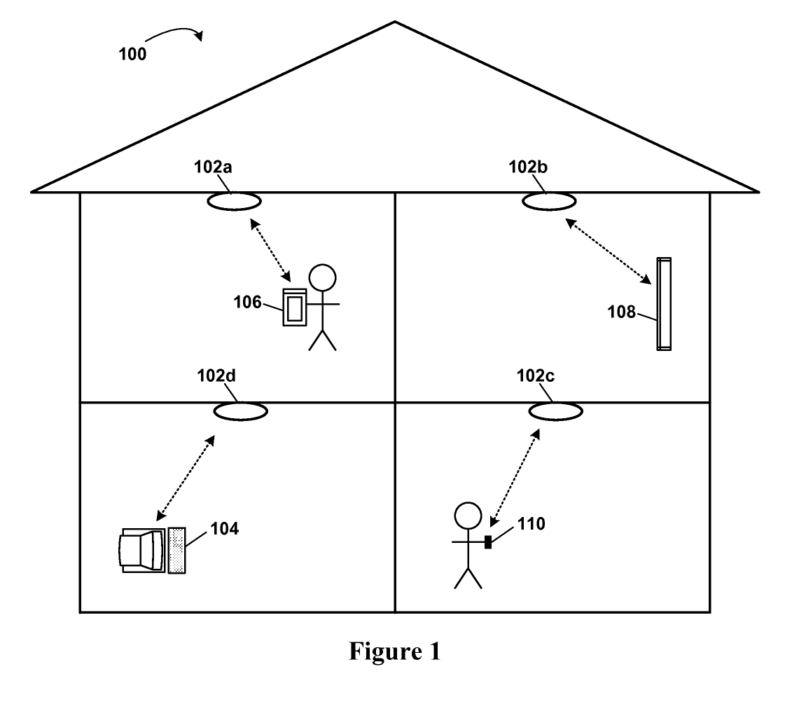

Referring to FIG. 1, depicted is a schematic elevational diagram of smoke detectors with wireless local area network capabilities in a dwelling, according to specific example embodiments of this disclosure. A dwelling, generally represented by the numeral 100, has a smoke detector 102 with wireless local area network capabilities in each room thereof as required by building codes. Electrical power (not shown) is supplied to each smoke detector 102 and either a wired communications bus (not shown), e.g., Ethernet local area network (LAN) cabling, etc., or a code approved wireless communications link, e.g., WLAN, WiFi, etc., may be used to communicate smoke alarm actuation, as required by the building codes.

Each smoke detector 102 may be used as an Ethernet transceiver, WLAN router and/or WLAN repeater to wirelessly connect a local area network (LAN) to various wireless capable digital devices, e.g., a personal computer 104, a tablet touch screen computer 106, a wireless home entertainment device 108 (cable or satellite television decoder, DVD or Blu-ray, etc.), and/or a smart cell phone 110. Transmit power from the WLAN portion of the smoke detector 102 may be minimal since wireless digital communications need only be effective within the room that the smoke detector 102 is located. Using low power transmission and encryption of the wireless digital signals from the smoke detector 102 will further enhance security of the WLAN and reduce unauthorized use thereof, e.g., network hacking.

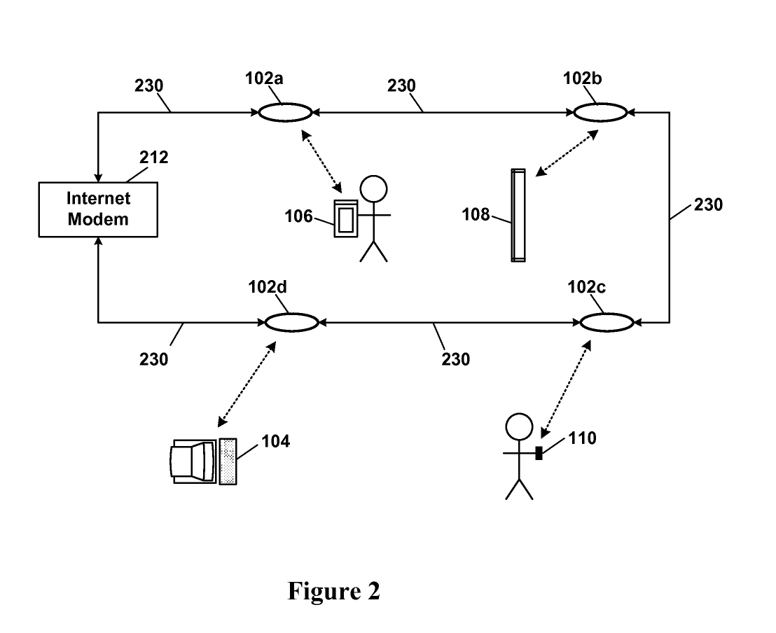

Referring to FIG. 2, depicted is a schematic block diagram of smoke detectors with wireless local area network capabilities in a dwelling, according to a specific example embodiment of this disclosure. The smoke detectors 102 with wireless local area network capabilities may function as wireless routers and repeaters on a wired local area network (LAN). Each of the LAN interface portions of the smoke detectors 102 may be coupled to a twisted pairs communications cable 230, e.g., CAT 5, etc., and an Internet modem 212. The wired LAN cables 230 and smoke detectors 102 may be configured in a ring bus topology as shown in FIG. 2. Each smoke detector 102 may provide wireless local area network capabilities to a wireless capable digital device, as described more fully hereinabove, in a room area proximate to the respective smoke detector 102.

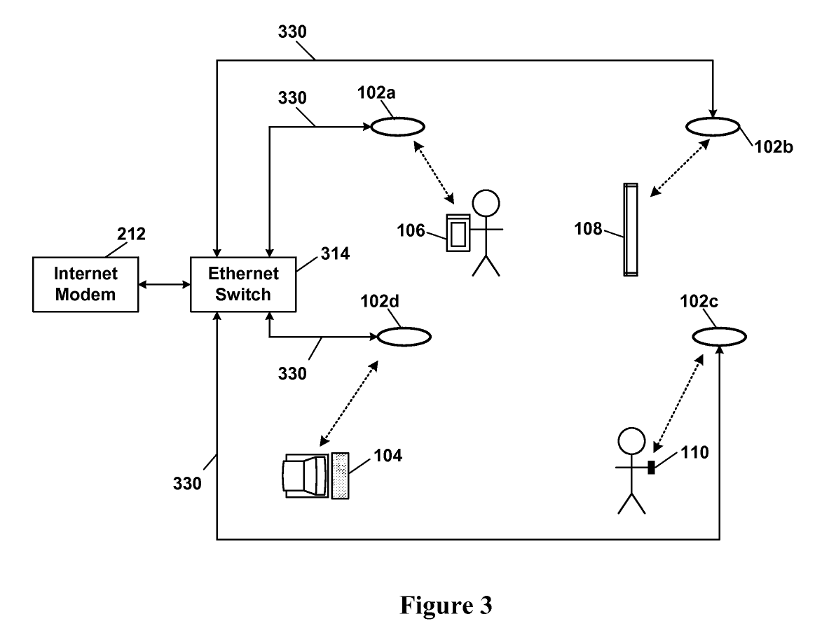

Referring to FIG. 3, depicted is a schematic block diagram of smoke detectors with wireless local area network capabilities in a dwelling, according to another specific example embodiment of this disclosure. The smoke detectors 102 with wireless local area network capabilities may function as wireless routers and repeaters on a wired local area network (LAN). Each of the LAN interface portions of the smoke detectors 102 may be coupled to a twisted pairs communications cable 330, e.g., CAT 5, etc., and an Ethernet switch 314. The Ethernet switch 314 may be coupled to an Internet modem 212. The wired LAN cables 330 and smoke detectors 102 may be configured in a star bus topology as shown in FIG. 3. Each smoke detector 102 may provide wireless local area network capabilities to a wireless capable digital device, as described more fully hereinabove, in a room area proximate to the respective smoke detector 102.

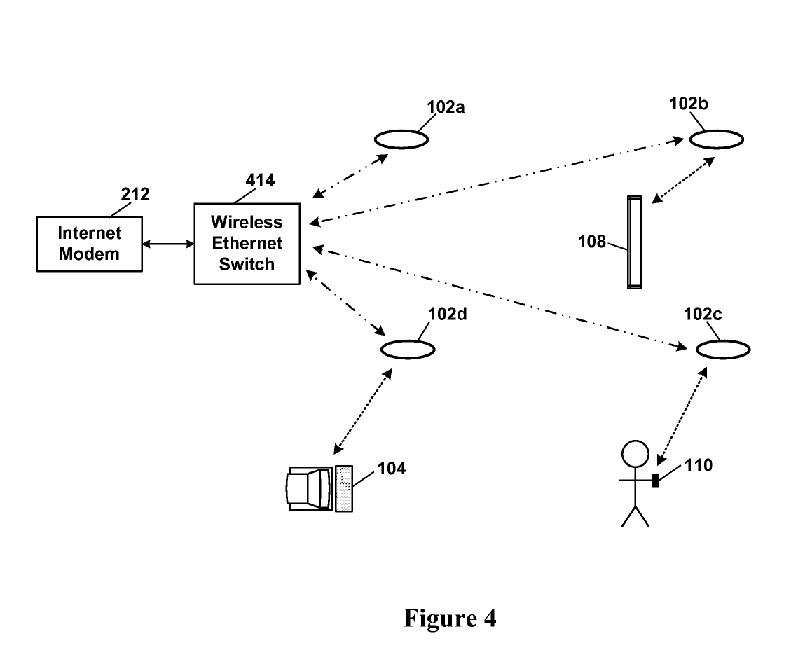

Referring to FIG. 4, depicted is a schematic block diagram of smoke detectors with wireless local area network capabilities in a dwelling, according to yet another specific example embodiment of this disclosure. The smoke detectors 102 with wireless local area network capabilities may function as wireless routers and repeaters in a wireless local area network (WLAN). Each of the WLAN interface portions of the smoke detectors 102 may wirelessly communicate with a wireless Ethernet switch 414. The Ethernet switch 414 may be coupled to an Internet modem 212. Each smoke detector 102 may provide wireless local area network capabilities to a wireless capable digital device, as described more fully hereinabove, in a room area proximate to the respective smoke detector 102. This wireless arrangement works when the smoke detectors 102 are within wireless signal range of the wireless Ethernet switch 414.

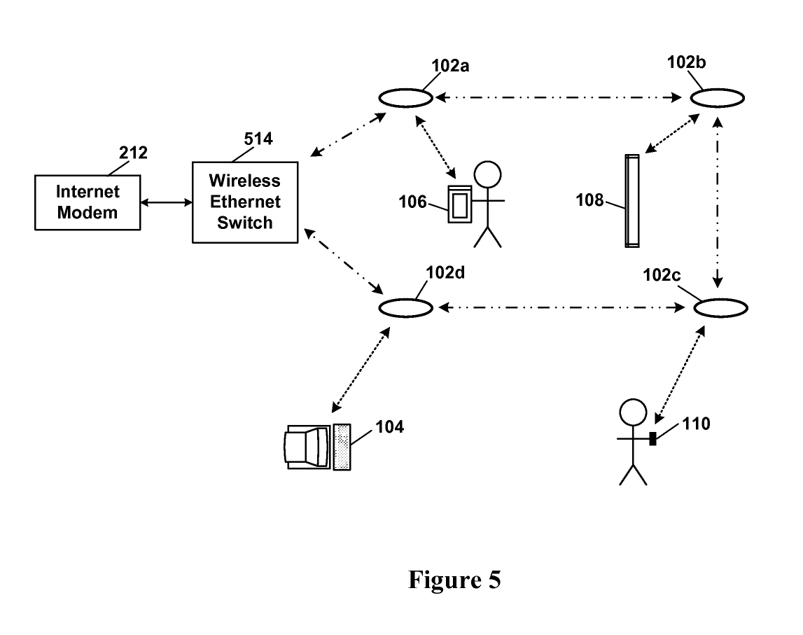

Referring to FIG. 5, depicted is a schematic block diagram of smoke detectors with wireless local area network capabilities in a dwelling, according to still another specific example embodiment of this disclosure. The smoke detectors 102 with wireless local area network capabilities may function as wireless routers and repeaters in a wireless local area network (WLAN). Each of the WLAN interface portions of the smoke detectors 102 may wirelessly communicate with either a wireless Ethernet switch 514 or be repeated through another smoke detector 102 that is spatially closer to the wireless Ethernet switch 514. The Ethernet switch 514 may be coupled to an Internet modem 212. Each smoke detector 102 may provide wireless local area network capabilities to a wireless capable digital device, as described more fully hereinabove, in a room area proximate to the respective smoke detector 102. This wireless arrangement works when all of the smoke detectors 102 may not be within wireless signal range of the wireless Ethernet switch 514.

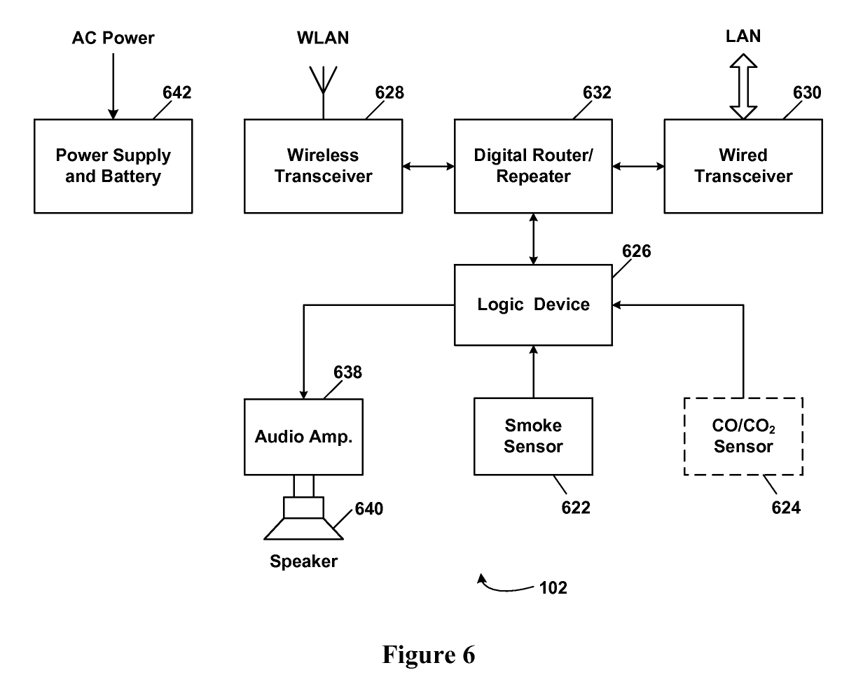

Referring to FIG. 6, depicted is a schematic block diagram of a smoke detector with wireless local area network capabilities, according to specific example embodiments of this disclosure. A smoke detector having enhanced audio and communications capabilities, generally represented by the numeral 102, may comprise a smoke sensor 622, a carbon monoxide and/or carbon dioxide sensor(s) 624, a logic device 626 having a memory, digital router/repeater logic 632 with store and forward logic and memory, a wireless transceiver 628 coupled to an antenna, a wired transceiver 630 that may be coupled to a wired local area network (LAN), an audio amplifier 638, a speaker 640, and a power supply and battery 642. The logic device 626 may be, for example but is not limited to, a microcontroller, a microprocessor, a digital signal processor (DSP), an application specific integrated circuit (ASIC), a field programmable gate array (FPGA), etc., and may have both digital and analog capabilities.

The smoke sensor 622 may be an ionization and/or optical smoke sensor, and the like. The sensor 624 may be a carbon monoxide and/or carbon dioxide sensor(s). The power supply 642 with battery backup may be powered from the house alternating current (AC) power electrical branch circuits. The logic device 626 may comprise analog and digital capabilities that may allow processing of a smoke detection signal from the smoke sensor 622, and/or a carbon monoxide and/or carbon dioxide signal from the CO/CO₂ sensor 624. Activation of a smoke and/or carbon monoxide/dioxide alarm may be initiated by the logic device 626 sensing the outputs from the smoke sensor 623 and/or CO/CO₂ sensor 624. The logic device 626 may further signal other smoke detectors 102 of the detected smoke alarm to meet building code requirements via the wired transceiver 630 over a code approved wired communications line, e.g., Ethernet LAN, etc., and/or the wireless transceiver 628 over a code approved WLAN, WiFi, etc., signal.

The wireless transceiver 628 and/or wired transceiver 630 may be part of or separate from the digital router/repeater logic 632, and the digital router/repeater logic 632 may be part of the logic device 622, e.g., a mixed signal microcontroller. It is contemplated and within the scope of this disclosure that the digital router/repeater logic 632 may comprise a microcontroller, an application specific integrated circuit (ASIC), a programmable logic array, a microprocessor, a digital signal processor (DSP), etc. One having ordinary skill in integrated circuit design and having the benefit of this disclosure could come up with an effective design using various digital and/or mixed signal integrated circuit devices.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. An apparatus for detecting smoke and providing wireless local area network communications, comprising:
a logic device;
a smoke sensor coupled to the logic device;
an audio amplifier coupled to the logic device;
a speaker coupled to the audio amplifier;
network store and forward logic and memory;
a communications interface coupled to the network store and forward logic, wherein the communications interface comprises a wireless interface coupled to a radio frequency antenna; and
a power supply coupled to and powering the logic device, the network store and forward logic, communications interface and audio amplifier;
wherein when the smoke sensor detects smoke the logic device generates at least one smoke alarm tone through the audio amplifier and to the speaker, and a smoke alarm signal through the communications interface; and
wherein the network store and forward logic through the communications interface communicates with at least one wireless digital device located in an area proximate to a respective one of the plurality of apparatus and a local area network (LAN) such that digital information content transfers between the at least one wireless digital device and the local area network.

2. The apparatus according to claim 1, wherein the communications interface further comprises a wired interface coupled to a wired communications bus.

3. The apparatus according to claim 2, wherein the wired communications bus is an Ethernet local area network.

4. The apparatus according to claim 1, wherein the communications interface is adapted to communicate with a wireless local area network (WLAN).

5. The apparatus according to claim 4, wherein the WLAN portion of the communications interface is IEEE 802.11 standard compliant.

6. The apparatus according to claim 1, wherein the smoke sensor is an ionization chamber smoke sensor.

7. The apparatus according to claim 1, wherein the smoke sensor is an optical smoke sensor.

8. The apparatus according to claim 4, wherein the communications interface and the network store and forward logic comprise a WLAN router.

9. The apparatus according to claim 4, wherein the communications interface and the network store and forward logic comprise a WLAN transceiver.

10. The apparatus according to claim 4, wherein the communications interface and the network store and forward logic comprise a WLAN repeater.

11. The apparatus according to claim 1, wherein the at least one wireless digital device is selected from the group consisting of a personal computer, a tablet touch screen computer, a wireless home entertainment device, and a smart cell phone.

12. The apparatus according to claim 1, further comprising a carbon monoxide sensor.

13. The apparatus according to claim 1, further comprising a carbon dioxide sensor.

14. The apparatus according to claim 1, wherein the logic device, and the network store and forward logic and memory are provided by a microcontroller.

15. The apparatus according to claim 1, wherein the logic device comprises a microcontroller.

16. The apparatus according to claim 1, wherein the logic device is selected from the group consisting of a microprocessor, a digital signal processor (DSP), an application specific integrated circuit (ASIC), and a field programmable gate array (FPGA).

17. A system for providing smoke detection and wireless local area network (WLAN) communications, said system comprising:
a plurality of apparatus providing smoke detection and wireless local area network (WLAN) communications, each of the plurality of apparatus comprising
a logic device,
a smoke sensor coupled to the logic device,
an audio amplifier coupled to the logic device,
a speaker coupled to the audio amplifier,
network store and forward logic and memory,
a communications interface coupled to the network store and forward logic, wherein the communications interface comprises a wireless interface coupled to a radio frequency antenna, and
a power supply coupled to and powering the logic device, the network store and forward logic, communications interface and audio amplifier;
wherein when the smoke sensor detects smoke the logic device generates at least one smoke alarm tone through the audio amplifier and to the speaker, and a smoke alarm signal through the communications interface; and
wherein the network store and forward logic through the communications interface communicates with at least one wireless digital device located in an area proximate to a respective one of the plurality of apparatus and a local area network such that digital information content transfers between the at least one wireless digital device and the local area network.

18. The system according to claim 17, wherein the local area network is an Ethernet local area network.

19. The system according to claim 17, wherein the local area network is the WLAN.

20. The system according to claim 17, wherein the at least one wireless digital device is selected from the group consisting of a personal computer, a tablet touch screen computer, a wireless home entertainment device, and a smart cell phone.

21. The system according to claim 17, wherein each of the plurality of apparatus comprise an Ethernet router.

22. The system according to claim 17, wherein each of the plurality of apparatus comprise an Ethernet transceiver.

23. The system according to claim 17, wherein each of the plurality of apparatus comprise an Ethernet repeater.
